(19) United States
(12) Patent Application Publication
(10) Pub. No.: US 2005/0251815 A1
(43) Pub. Date: Nov. 10, 2005

(54) OPTICAL DISK DRIVE HAVING CAPABILITY TO DIFFERENTIATE DISCS ACCORDING TO SIZE

(76) Inventor: Jui-Chiang Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/907,833

(22) Filed: Apr. 18, 2005

(30) Foreign Application Priority Data
May 5, 2004 (TW) 093112660

(51) Int. Cl. G11B 17/04; G11B 33/12

(52) U.S. Cl. 720/626

(57) ABSTRACT

An optical disk drive has a disk slot for a disk to be inserted into, a roller for conveying the disk inserted in the disk slot and having a central region, and a plurality of sensing modules installed in the disk slot for sensing the position of the disk inserted in the disk slot and for enabling the roller to convey the disk while all have sensed the disk. One of the sensing modules is installed adjacent to the central region of the roller.

### BACKGROUND OF INVENTION

1. Field of the Invention

The present invention relates to an optical disc drive, and more particularly, to an optical disc drive having a capability to differentiate discs according to their sizes.

2. Description of the Prior Art

In recent years, owing to the rapid development of digital technology, analog data such as video and audio data can be transformed into digital data for easy storage and transmission. Thus, there is an increasing demand for digital data storage media. Conventional data storage media such as magnetic tapes and magnetic discs have limited data storage capacity and are not adequate to store huge amounts of digital data. Optical discs have therefore been developed to fill this need. An optical disc drive is an electronic device used to access data of an optical disc.

Concerning disc loading, optical disc drives can be divided into three types: hinged-cover, sliding-tray, and slot-loading. Having the advantage of conveying a disc in and out directly, slot-loading optical disc drives are becoming one of the most popular types of optical disc drives.

Please refer to FIG. 1, which is a schematic diagram of a slot-loading optical disc drive 10 according to the prior art. The slot-loading optical disc drive 10 comprises a disc slot 12 for a disc to be inserted into, a roller 14 installed behind the disc slot 12, and a large disc platter 20 for accommodating large discs.

The slot-loading optical disc drive 10 shown in FIG. 1 allows insertion of a large disc (standard 12 cm size), and does not inhibit insertion of smaller diameter discs (8 cm size). In other words, either a large disc or a small disc can be inserted into a central region of the disc slot 12 and then be conveyed by the roller 14 into the large disc platter 20. However, because the slot-loading optical disc drive 10 comprises only the large disc platter 20 specifically designed for large discs, and the roller 14 conveys a disc inserted into the disc slot 12 regardless of the diameter of the disc, a small disc could be inadvertently inserted into the drive 10 potentially resulting in damage to the disc itself or the drive 10.

For example, after conveying and placing a small disc into a large disc platter, a slim-type slot-loading optical disc drive manufactured by Panasonic Inc. cannot convey another disc unless it takes the extra step to reject the small disc. However, a desktop slot-loading optical disc drive manufactured by Pioneer Inc. does not have such good performance. After being conveyed into the large disc platter, the small disc damages the desktop slot-loading optical disc drive.

### SUMMARY OF INVENTION

It is therefore a primary objective of the claimed invention to provide an optical disc drive having a capability to differentiate discs according to their sizes, so as to overcome the drawbacks of the prior art.

According to the claimed invention, the optical disc drive includes a disc slot for a disc to be inserted into, a roller for conveying the disc inserted into the disc slot, and a plurality of sensing modules installed inside the disc slot for sensing a position of the disc inserted into the disc slot. The roller starts to operate only when more than a predetermined number of the sensing modules have sensed the disc inserted into the disc slot.

According to the preferred embodiment, the predetermined number equals three, each of the sensing modules comprises a light source for emitting light and a corresponding light sensor for sensing the light emitted from the light source, and the roller starts to convey the disc inserted into the disc slot only when all of the light sensors of the more than the predetermined number of sensing modules do not receive substantial light emitted from their corresponding light sources.

It is an advantage of the claimed invention that an optical disc drive having a plurality of sensing modules capable of sensing a position of a disc inserted into the disc slot and of differentiating the disc according to its size, and a roller for conveying the disc only when the size of the disc equals a predetermined size will not wrongly convey an incompatible disc.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a slot-loading optical disc drive according to the prior art.

FIG. 2 is a schematic diagram of a slot-loading optical disc drive of the preferred embodiment according to the present invention.

FIG. 3 is a flowchart demonstrating an operating process of the slot-loading optical disc drive shown in FIG. 2 according to the present invention.

FIG. 4 and FIG. 5 are schematic diagrams demonstrating the slot-loading optical disc drive shown in FIG. 2 conveying a small disc according to the present invention.

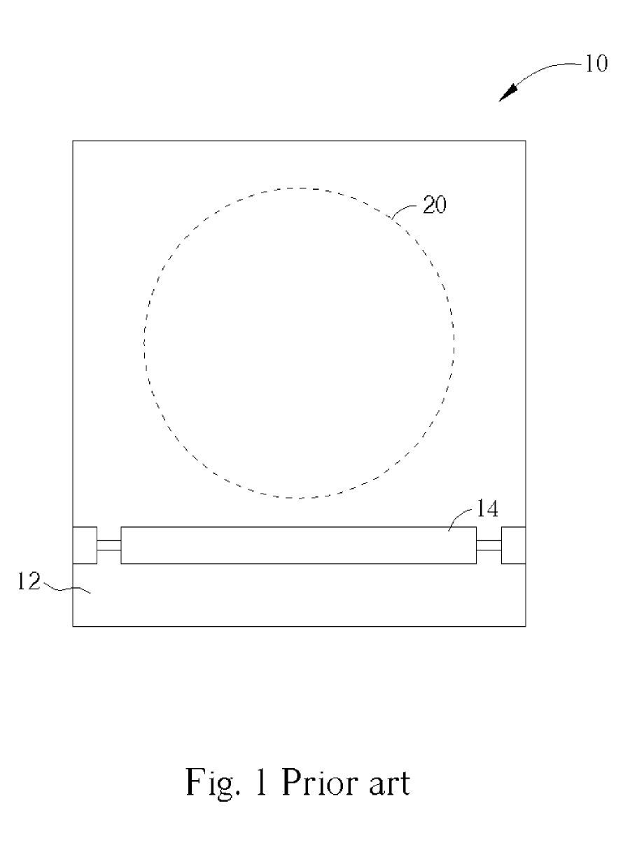

### DETAILED DESCRIPTION

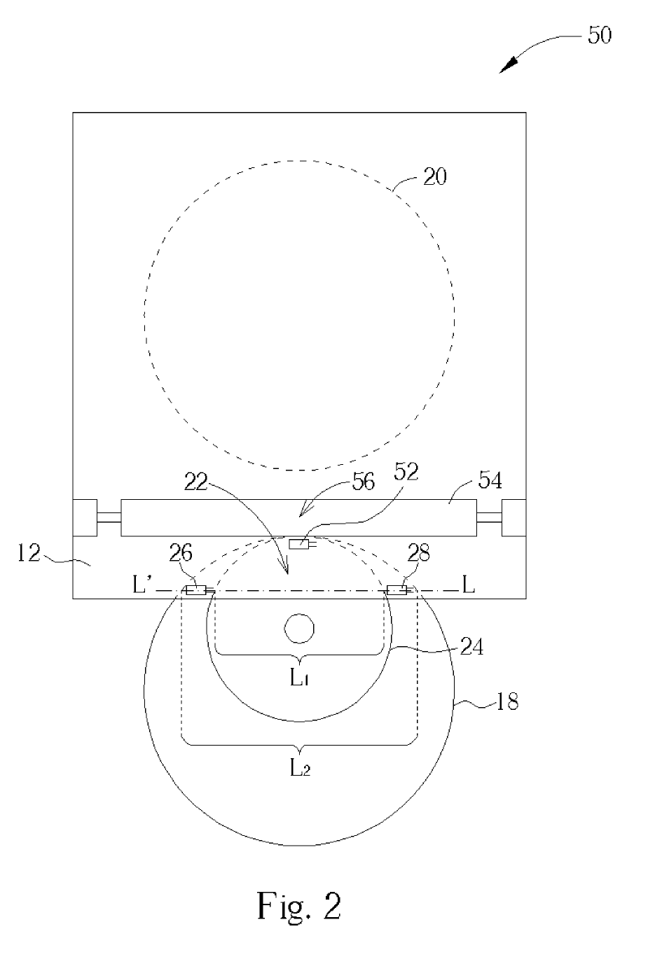

Please refer to FIG. 2, which is a schematic diagram of a slot-loading optical disc drive 50 of the preferred embodiment according to the present invention. The slot-loading optical disc drive 50 comprises a disc slot 12, a roller 54 having a central region 56, a large disc platter 20, a first sensing module 26, a second sensing module 28, and a third sensing module 52 installed in a middle region 22 inside the disc slot 12 and adjacent to the central region 56 of the roller 54.

All of the first, the second and the third sensing modules 26, 28 and 52 have capabilities to sense a position of a disc inserted into the disc slot 12 and consequently to determine whether the disc has a size the same as that of a large (12 centimeters) disc 18 or has a size the same as that of a small (8 centimeters) disc 24. The roller 54 starts to convey the disc when all of the sensing modules 26, 28 and 52 have sensed a disc and determined that the disc has a size the same as that of the large disc 18.

As shown in FIG. 2, where the first sensing module 26 and the second sensing module 28 are installed inside the disc slot 12 relates to a size of any disc suitable to be inserted into the disc slot 12. In practice, the first sensing module 26 as well as the second sensing module 28 have to be installed to have between them a distance longer than a length L₁, a length of a coinciding part of the small disc 24 on a line LL′ on which the first and the second sensing modules 26 and 28 are installed. When the small disc 24 is inserted into the disc slot 12 and has a front end almost contacting the roller 54, length L₁ can be seen to be shorter than a length L₂, which is a length of a coinciding part of the large disc 18 on the line LL′ when the large disc 18 is inserted into the disc slot 12 and has a front end almost contacting the roller 54. Therefore, since the small disc 24 cannot be sensed by the first, the second and the third sensing modules 26, 28 and 52 simultaneously, the small disc 24 inserted into the middle region 22 of the disc slot 12 has no chance to be conveyed by the roller 54 into the large disc platter 20. On the contrary, if a disc inserted into the middle region 22 of the disc slot 12 is the large disc 18, since the length L₂ is longer than the distance between the first sensing module 26 and the second sensing module 28, the first, the second and the third sensing modules 26, 28 and 52 can sense the large disc 18 simultaneously, and the roller 14 therefore conveys the large disc 18 into the large disc platter 20.

According to the preferred embodiment, the slot-loading optical disc drive 50 comprises only three sensing modules. However, a disc drive of the present invention can comprise more than three sensing modules. Moreover, although the three sensing modules shown in FIG. 2 have an arc-shaped layout, the sensing modules of the disc drive of the present invention can have a layout of any shape in addition to an arc. For example, the sensing modules can all be disposed along a line.

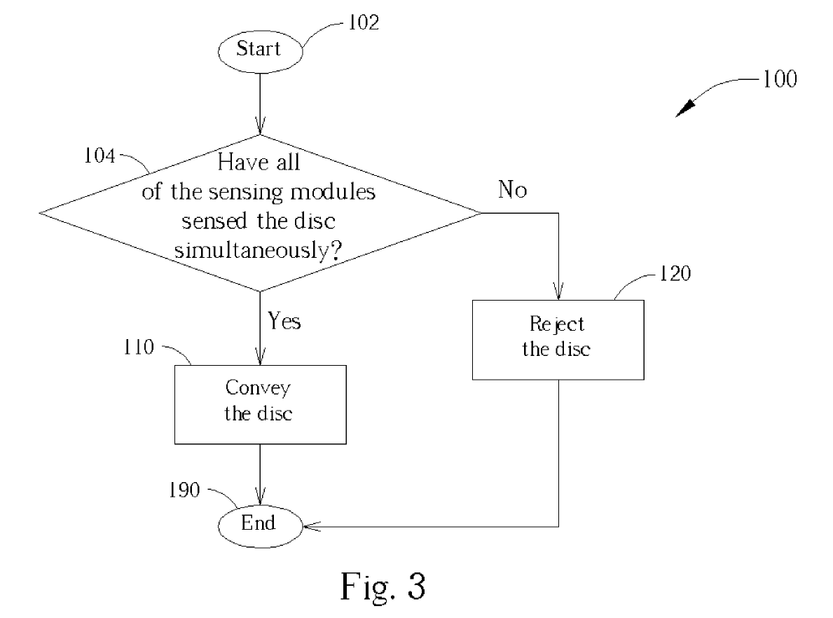

Please refer to FIG. 3, which is a flowchart of an operating process 100 of the slot-loading optical disc drive 50 of the preferred embodiment according to the present invention. The operating process 100 comprises the following steps:

Step 102: Start;

(A disc is ready to be inserted into the slot-loading optical disc drive 50)

Step 104: Have the first, the second and the third sensing modules 26, 28 and 52 sensed the disc simultaneously? If yes, go to step 110, or else go to step 120;

Step 106: The roller 54 conveys the disc into the large disc platter 20. Go to step 190;

(That the operating process 100 comes this far represents that the disc is the large disc 18, since only the large disc 18 has a capability to cover the first, the second and the third sensing modules 26, 28 and 52 simultaneously.)

Step 120: The roller 54 rejects the disc. Go to step 190; and

(That the operating process 100 comes this far represents that the disc is not the large disc 18. The roller 54 rejects the disc to avoid the problem of the small disc 24 getting stuck in the large disc platter 20. A disc drive of the present invention can further comprise a display device such as a liquid crystal display for display a warning message like “Only supports 12-centimeter discs” to remind users that the disc drive supports the large disc 18 only when at least one of the sensing modules of the disc drive does not sense the disc and the disc is determined not to be the large disc 18.)

Step 190: End.

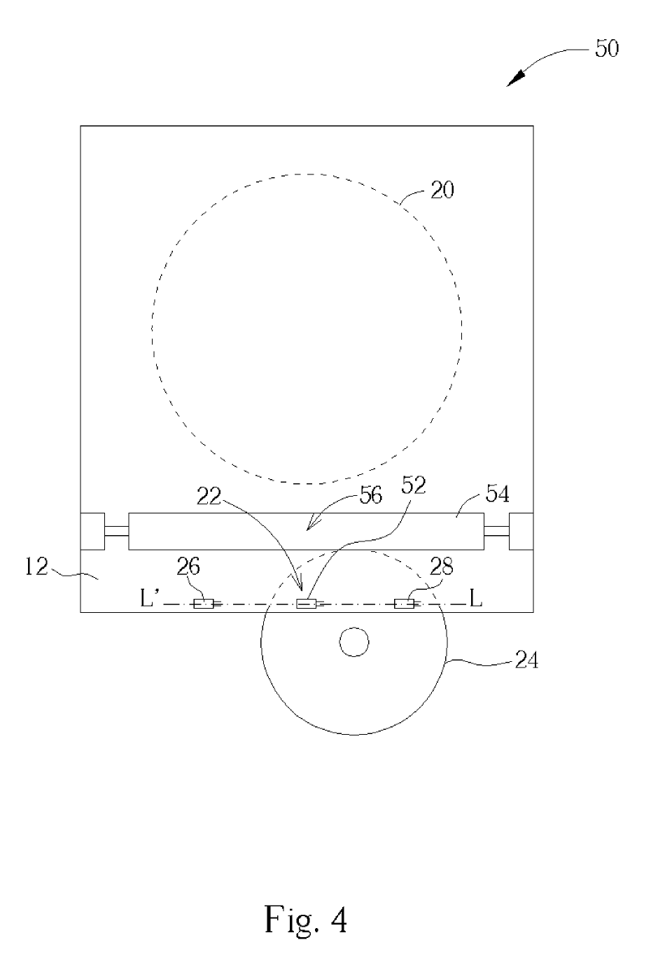

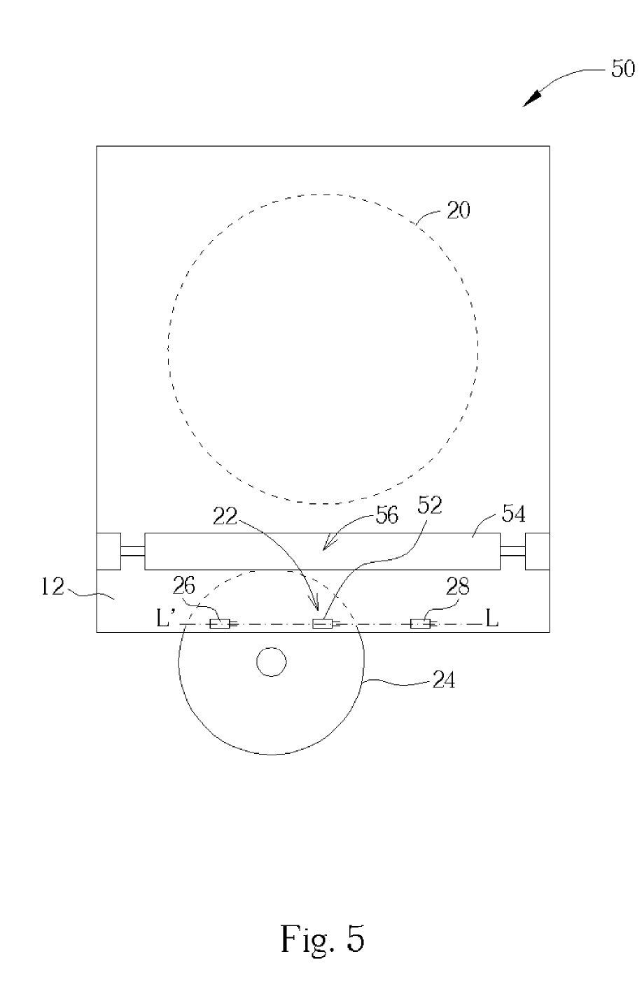

In addition to being inserted into the middle region 22 of the disc slot 12 of the slot-loading optical disc drive 50 to cover the third sensing module 52 only, the small disc 24 shown in FIG. 4 and FIG. 5 can be inserted into the right region or the left region of the disc slot 12 respectively. This leads to another two possibilities that the operating process 100 addresses in step 120. The small disc 24 shown in FIG. 4 covers the second and the third sensing modules 28 and 52 only. The small disc 24 shown in FIG. 5 covers the first and the third sensing modules 26 and 52 only.

In the preferred embodiment, each of the first, the second and the third sensing modules 26, 28 and 52 comprises a light source for emitting light, and a light sensor corresponding to the light source for sensing the light emitted from the light source. The roller 54 does not convey a disc inserted into the middle region 22 of the disc slot 12 until all of the light sensors of the first, the second and the third sensing modules 26, 28 and 52 do not sense the light emitted by the corresponding light sources, implying that the disc inserted into the middle region 22 of the disc slot 12 is the large disc 18, the only disc capable of covering all of the light emitted by the light sources from projecting onto the light sensors.

In contrast to the prior art, the present invention can provide an optical disc drive comprising a roller and a plurality of sensing modules. The sensing modules have the capability to differentiate discs inserted into the optical disc drive according to their sizes and the roller does not convey a disc unless the disc has a predetermined size. Therefore, the optical disc drive of the present invention has little chance of conveying a small disc.

Those skilled in the art will readily observe that numerous modifications and alterations of the device and method may be made while retaining the teachings of the invention. Accordingly, the above disclosure should be construed as limited only by the metes and bounds of the appended claims.

1. An optical disc drive having a capability to differentiate discs according their sizes, the optical disc drive comprises:
a disc slot for a disc to be inserted into;
a roller for conveying the disc inserted into the disc slot; and
a plurality of sensing modules installed inside the disc slot for sensing a position of the disc inserted into the disc slot;
wherein the roller starts to operate only when more than a predetermined number of the sensing modules have sensed the disc inserted into the disc slot.

2. The optical disc drive of claim 1, wherein the predetermined number equals three.

3. The optical disc drive of claim 2, wherein the roller comprises a central region, and one of the three sensing modules is a first sensing module installed adjacent to the central region.

4. The optical disc drive of claim 3, wherein the other of the three sensing modules are a second sensor installed on one side of the first sensing module, and a third sensing module installed on the other side of the first sensor.

5. The optical disc drive of claim 1, wherein the roller conveys the disc inserted into the disc slot only when the more than the predetermined number of the sensing modules have sensed the disc.

6. The optical disc drive of claim 1 further comprising a display device for displaying a predetermined warning message when at least one of the more than the predetermined number of sensing modules has not sensed the disc inserted into the disc slot.

7. The optical disc drive of claim 6, wherein the display device is a liquid crystal display.

8. The optical disc drive of claim 1, wherein each of the sensing modules comprises a light source for emitting light and a corresponding light sensor for sensing the light emitted from the light source, and the roller starts to operate only when all of the light sensors of the more than the predetermined number of sensing modules do not receive substantial light emitted from their corresponding light sources.

9. The optical disc drive of claim 8, wherein the roller conveys the disc only when all of the light sensors of the more than the predetermined number of sensing modules do not receive substantial light emitted from their corresponding light sources.
